(19) United States
(12) Patent Application Publication
(10) Pub. No.: US 2003/0096525 A1
(43) Pub. Date: May 22, 2003

(54) Socket on a printed circuit board

(76) Inventor: Feng-Chien Hsu, Hsinchuang City (TW)

Correspondence Address: VENABLE, BAETJER, HOWARD AND CIVILETTI, LLP, P.O. BOX 34385, WASHINGTON, DC, 20043-9998, US

(21) Appl. No.: 09/988,795

(22) Filed: Nov. 20, 2001

(51) Int. Cl. H01R 4/50

(52) U.S. Cl. 439/342

(57) ABSTRACT

A socket for a PCB has a plurality of apertures and a plurality of connecting strips respectively inserted in the apertures. The connecting strips each have two opposite upright portions; and a lateral portion between the upright portions. Each upright portion has a wall; a protrusion formed at a front side thereof; a neck formed at the top of the wall, extending upward from the wall and bent inward; and a head formed at the top of the neck and having a front end bent outward. A plurality of solder balls is respectively formed under the lateral portions of the connecting strips to bond the connecting strips on a printed circuit board by melting the solder ball.

### BACKGROUND OF THE INVENTION

1. Field of the Invention

The present invention is related to a socket on a printed circuit board, and more particularly to a connecting strip in the socket.

2. Description of Related Art

In general, a CPU is detachably mounted in a socket on a main board of a computer. The socket is integrated with the main board and has a plurality of apertures in which pins of the CPU are inserted. A connecting strip is mounted in each aperture and is electrically connected to a respective pin of the CPU. Conventional connecting strips are inserted into the apertures through the ends of the apertures corresponding to the mounted chip and are held in position by fastening means in the apertures. However, when a CPU is removed from the socket, the conventional connecting strips may remain attached to the CPU pins and be pulled out through the upper ends of the apertures.

Therefore, the invention provides an improved connecting strip for a PCB to mitigate and/or obviate the aforementioned problems.

### SUMMARY OF THE INVENTION

The main objective of the invention is to provide a socket in which connecting strips are securely mounted.

Other objects, advantages and novel features of the invention will become more apparent from the following detailed description when taken in conjunction with the accompanying drawings.

### BRIEF DESCRIPTION OF THE DRAWINGS

FIG. 1 is a partially exploded perspective view of a connecting strip and a socket in accordance with the invention;

FIG. 2 is a perspective view showing that the connecting strip is made from a sheet metal;

FIG. 3 is a top view of the connecting strip with a pin of a CPU inserted in the socket;

FIG. 4 is a top view of the connecting strip in electrical contact with the pin of the CPU in FIG. 4;

FIG. 5 is a sectional view of the connecting strip in an aperture of the socket, taken along the line “5-5” in FIG. 4; and

FIG. 6 is a sectional view of the connecting strip bonded on a printed circuit board.

### DETAILED DESCRIPTION OF THE PREFERRED EMBODIMENT

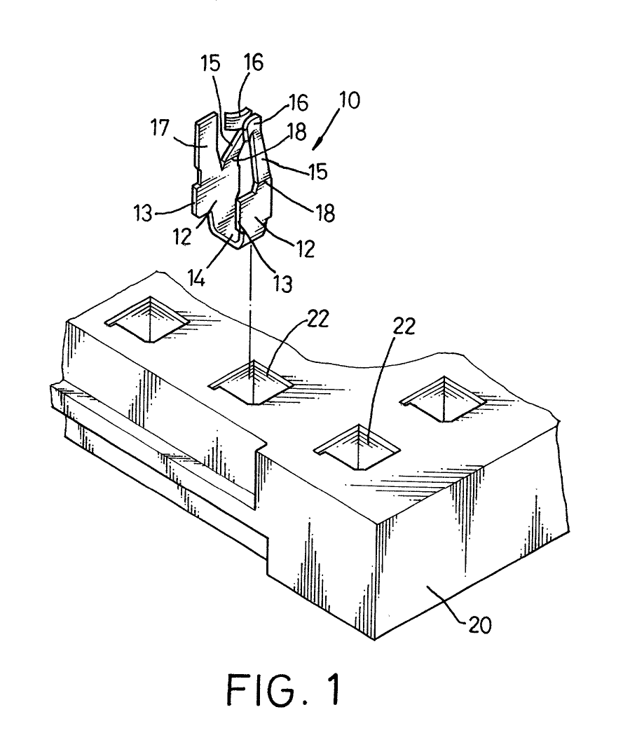

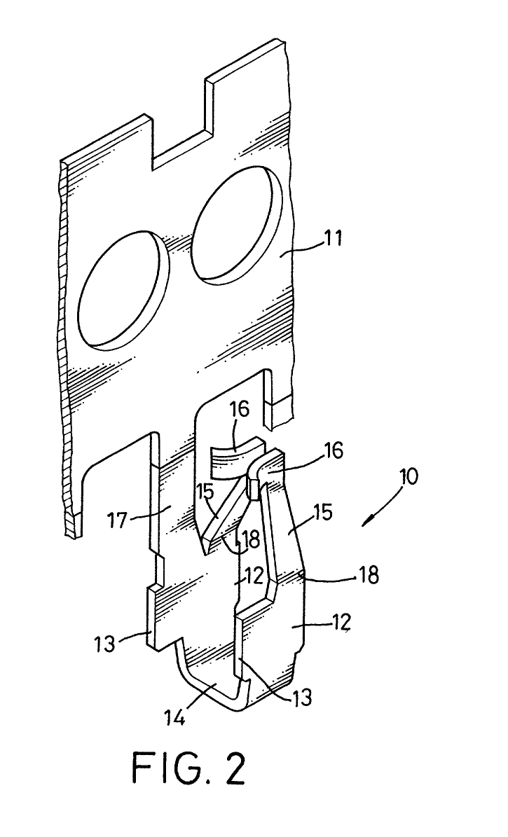

With reference to FIGS. 1 and 2, a connecting strip (10) in accordance with the invention is made from a sheet metal (11) by punching whereby the sheet metal is separated into a processed portion, i.e. the connecting strip, and a waste portion. The connecting strip (10) has a U-shape with two upright portions (not numbered) and a lateral portion (14) extending between the opposite upright portions.

Each of the upright portions has a wall (12) and a neck (15) is formed at the top of the wall (12) and extends upward from the wall (12). A head (16) is formed at the top of the neck (15). A crease (18) is formed between the neck (15) and the wall (12) to assist specific required deformation of the wall. Each neck (15) is bent inward at the crease (18) to bring the heads (16) close to each other. The heads (16) each have a front end bent outward to define an outward taper between the heads (16).

The wall (12) adjacent the waste portion of the sheet metal (11) has a connecting portion (17) formed on a top edge of the wall (12) and extending upward to connect with the waste portion of the sheet metal (11). The wall (12) with the connecting portion (17) has a first protrusion (13) formed at a front side thereof, and the wall (12) without the connecting portion (17) has a second protrusion (13a) formed at a front side thereof. The first protrusion (13) projects out further than the second protrusion (13a).

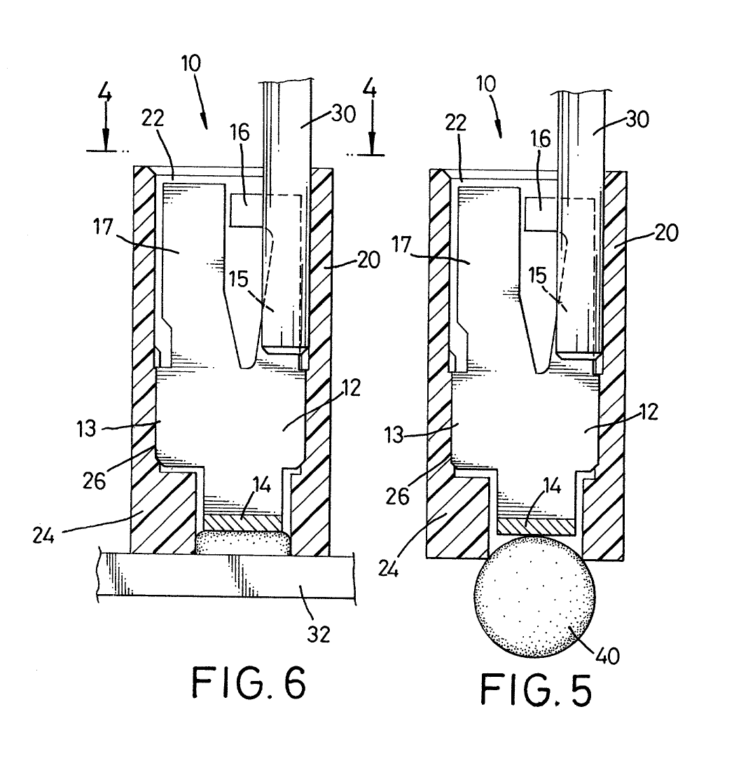

With reference to FIGS. 1, 3, 5 and 6, a socket (20) in which a CPU is mounted has a plurality of apertures (22) defined through the socket (20). The apertures (22) each have a step (24) formed on a bottom of an inner wail thereof. A slot (26) is defined at a side of the step (24).

The connecting strip (10) is inserted into the aperture (22) through a top opening of the aperture (22). The walls (12) of the connecting strip (10) respectively abut two opposite inner walls that are perpendicular to the inner wall with the step (24). The first protrusion (13) is received in the slot (26), and the two protrusions (13, 13a) are located above the step (24). A solder ball (40) is formed under the lateral portion (14) of connecting strip (10). The socket (20) is bonded to a printed circuit board (32) by melting the solder ball (41), and the connecting strip (10) is electrically connected to a circuit on the main board (32). After the connecting strip (10) is bonded, the connecting strip (10) is cut off from the waste portion of the sheet metal (11) at the connecting portion (17).

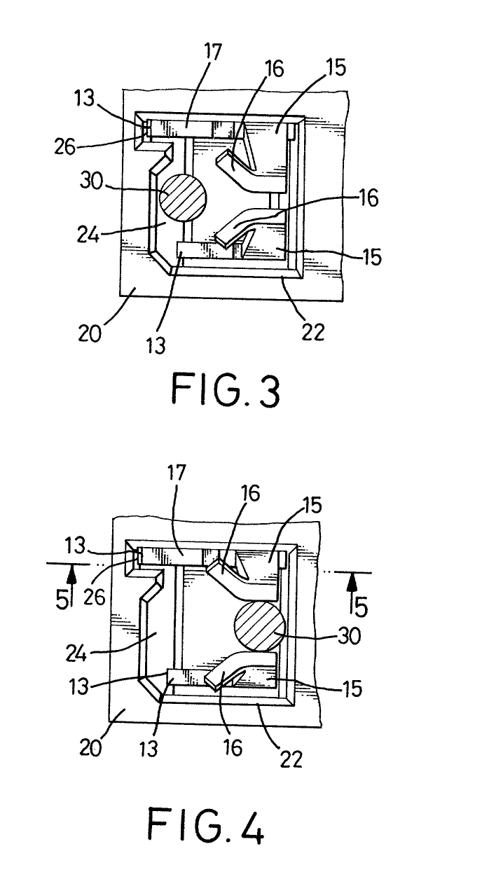

With reference to FIGS. 3 and 4, when a pin (30) of a CPU is inserted in the aperture (22), the pin (30) is first located in front of the heads (16). After the pin (30) has been inserted into the aperture (22), a fastening means (not shown) on the socket (20) moves the CPU and the pin (30) toward the heads (16) and the pin (30) is clamped between the heads (16). The pin (30) is electrically connected to the connecting strip (10) due to being clamped between the heads (16).

When the CPU is removed from the socket (20), the pin (30) is first laterally moved away from the heads (16) and will not attach the connecting strip (10). Furthermore, the connecting strip (10) is secured by the solder ball (40), so that the connecting strip (10) will not be pulled out of the aperture (22) when the CPU is removed from the socket (20).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A socket (20) for a PCB comprising:
a plurality of apertures (22), the apertures (22) each having a step (24) formed at a bottom of an inner wall;
a plurality of connecting strips (10) respectively inserted in the apertures (22) through top ends of the plurality of apertures (22), the connecting strips (10) each having two opposite upright portions; and a lateral portion (14) extending between the upright portions, wherein each upright portion has a wall (12), a protrusion (13) formed at a front side thereof and located above the step (24), a neck (15) formed at the top of the wall (12), extending upward from the wall (12) and bent inward, and a head (16) formed at the top of the neck (15) and having a front end bent outward; and
a plurality of solder balls (40) respectively formed under the lateral portions (14) of the connecting strips (10) to bond the connecting strips (10) on a printed circuit board (32) by melting the solder ball (40).

2. A socket on a PCB as claimed in claim 1, wherein one of the walls (12) has a connecting portion (17) formed on a top edge of the wall (12) and extending upward.

3. A socket on a PCB as claimed in claim 2, wherein the protrusion (13) on the wall (12) with the connecting portion (17) projects outwardly further than the protrusion (13) on the wall (12) without the connecting portion (17).

4. A socket on a PCB as claimed in claim 3, wherein the aperture (22) has a slot (26) defined at a side of the step (24) to receive the protrusion (13) on the wall (12) with the connecting portion (17).

5. A socket on a PCB as claimed in claim 1, wherein the upright portions each have a crease (18) formed between the wall (12) and the neck (15).
